(19) United States
(12) Patent Application Publication
(10) Pub. No.: US 2009/0251306 A1
(43) Pub. Date: Oct. 8, 2009

(54) Vehicle deceleration warning device

(75) Inventor: Hung-Chin Yang, Kaohsiung City (TW)

Correspondence Address: STEPTOE & JOHNSON LLP, 1330 CONNECTICUT AVENUE, N.W., WASHINGTON, DC, 20036, US

(73) Assignee: Chih-Ching TSENG, Koahsiung City (TW)

(21) Appl. No.: 12/416,442

(22) Filed: Apr. 1, 2009

(30) Foreign Application Priority Data
Apr. 2, 2008 (TW) 097205643

(51) Int. Cl. B60Q 1/50

(52) U.S. Cl. 340/467

(57) ABSTRACT

A vehicle deceleration warning device is adapted for installation on a vehicle having an accelerator mechanism, and includes a detecting unit, a warning unit and a control unit. The detecting unit is adapted to for detecting driver operation of the accelerator mechanism, and is configured to output a first signal when a vehicle driver manipulates the accelerator mechanism and to output a second signal when the vehicle driver releases the accelerator mechanism. The warning unit is adapted to be mounted on the vehicle and is operable so as to generate a warning output. The control unit is coupled to the detecting unit and the warning unit, responds to the first signal from the detecting unit by deactivating the warning unit, and responds to the second signal from the detecting unit by controlling the warning unit to generate the warning output.

### CROSS-REFERENCE TO RELATED APPLICATION

This application claims priority of Taiwanese Application No. 097205643, filed on Apr. 2, 2008.

### BACKGROUND OF THE INVENTION

1. Field of the Invention

The present invention relates to a vehicle deceleration warning device, more particularly to a vehicle deceleration warning device that is capable of generating a warning output before a brake mechanism is operated.

2. Description of the Related Art

Generally, a vehicle driver becomes aware of deceleration of a front vehicle only from a brake light set of the front vehicle, and cannot accurately estimate a speed of the front vehicle via visual inspection. Although the driver may reduce speed of the vehicle driven thereby after noticing that the brake light set of the front vehicle is turned on, a reaction time is needed before the driver steps on a brake pedal of the vehicle driven thereby. Therefore, traffic accidents can happen when a front vehicle decelerates and a rear vehicle driving at a fast speed has yet to decelerate due to delayed reaction by the driver of the rear vehicle.

### SUMMARY OF THE INVENTION

An object of the present invention is to provide a vehicle deceleration warning device that is capable of generating a warning output before a brake mechanism is operated, thereby warning rear vehicles at an earlier time.

Accordingly, a vehicle deceleration warning device of the present invention is adapted for installation on a vehicle having an accelerator mechanism, and comprises a detecting unit, a warning unit and a control unit. The detecting unit is adapted for detecting driver operation of the accelerator mechanism, and is configured to output a first signal when a vehicle driver manipulates the accelerator mechanism and to output a second signal when the vehicle driver releases the accelerator mechanism. The warning unit is adapted to be mounted on the vehicle and is operable so as to generate a warning output. The control unit is coupled to the detecting unit and the warning unit, responds to the first signal from the detecting unit by deactivating the warning unit, and responds to the second signal from the detecting unit by controlling the warning unit to generate the warning output.

Another object of the present invention is to provide a warning light controller adapted for controlling a warning light set of a vehicle.

Accordingly, a warning light controller of the present invention is adapted for installation on a vehicle having an accelerator mechanism and a warning light set, and comprises a detecting unit and a control unit. The detecting unit is adapted for detecting driver operation of the accelerator mechanism, and is configured to output a first signal when a vehicle driver manipulates the accelerator mechanism and to output a second signal when the vehicle driver releases the accelerator mechanism. The control unit is coupled to the detecting unit, is adapted to be coupled to the warning light set, responds to the first signal from the detecting unit by deactivating the warning light set, and responds to the second signal from the detecting unit by controlling the warning light set to generate a warning output.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating driver operation of an accelerator mechanism of a vehicle;

FIG. 2 is a schematic block diagram of a first preferred embodiment of a vehicle deceleration warning device of the present invention;

FIG. 3 is a flow chart illustrating operation of the first preferred embodiment;

FIG. 4 is a perspective view of a second preferred embodiment of the vehicle deceleration warning device of the present invention;

FIG. 5 is a circuit diagram of a third preferred embodiment of the vehicle deceleration warning device of the present invention;

FIG. 6 is a schematic block diagram of the third preferred embodiment;

FIG. 7 is a schematic block diagram of a fourth preferred embodiment of the vehicle deceleration warning device of the present invention;

FIG. 8 is a flow chart illustrating operation of the fourth preferred embodiment; and

FIG. 9 is a schematic block diagram of a fifth preferred embodiment of the vehicle deceleration warning device of the present invention.

### DETAILED DESCRIPTION OF THE PREFERRED EMBODIMENTS

Before the present invention is described in greater detail, it should be noted that like elements are denoted by the same reference numerals throughout the disclosure.

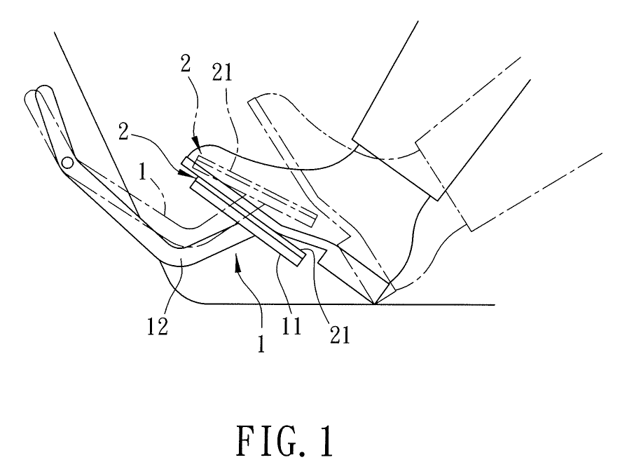

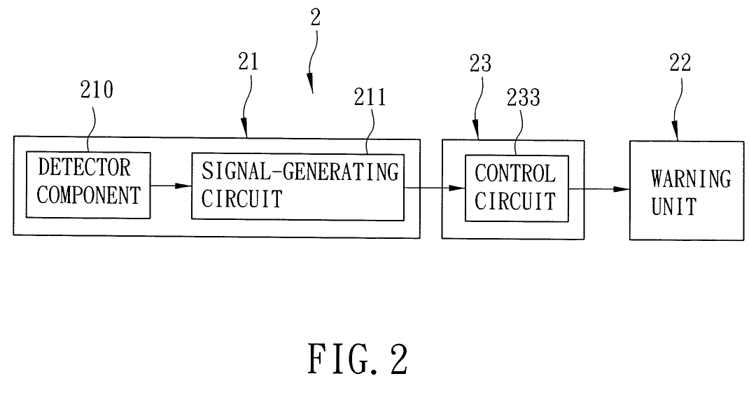

Referring to FIGS. 1 and 2, a first preferred embodiment of a vehicle deceleration warning device 2 of the present invention is adapted for installation on a vehicle having an accelerator mechanism 1. The vehicle deceleration warning device 2 includes a detecting unit 21 adapted for detecting driver operation of the accelerator mechanism 1, a warning unit 22 adapted to be mounted on the vehicle and operable so as to generate a warning output, and a control unit 23 coupled to the detecting unit 21 and the warning unit 22.

The detecting unit 21 is configured to output a first signal when a vehicle driver manipulates the accelerator mechanism 1 and to output a second signal when the vehicle driver releases the accelerator mechanism 1. Preferably, the detecting unit 21 is a pressure-sensitive unit that is adapted for detecting a pressure exerted upon the accelerator mechanism 1 by the vehicle driver, that outputs the first signal when the pressure is detected, and that outputs the second signal when the pressure is not detected. The detecting unit 21 includes a detector component 210 associated with the accelerator mechanism 1 for detecting driver operation of the accelerator mechanism 1, and a signal-generating circuit 211 electrically connected to the detector component 210 for generating one of the first and second signals based upon an output of the detector component 210. In this embodiment, the detector component 210 is a piezoelectric plate disposed on a pedal 11 of the accelerator mechanism 1 for detecting whether the vehicle driver steps on the pedal 11. In practice, the detector component 210 can be one associated with a linkage 12 of the accelerator mechanism 1 for detecting movement of the linkage 12 due to the vehicle driver stepping on the accelerator mechanism 1. Preferably, the warning unit 22 is a warning light set adapted to be mounted on the vehicle for generating the warning output, or a brake light set of the vehicle. In practice, the warning unit 22 may be, but is not limited to, a high brightness light-emitting-diode lamp set.

The control unit 23 includes a control circuit 233 for receiving one of the first and second signals generated by the signal-generating circuit 211 of the detecting unit 21 and for controlling operation of the warning unit 22 accordingly. The control circuit 233 responds to the first signal from the signal-generating circuit 211 by deactivating the warning unit 22, and responds to the second signal from the signal-generating circuit 211 by controlling the warning unit 22 to generate the warning output.

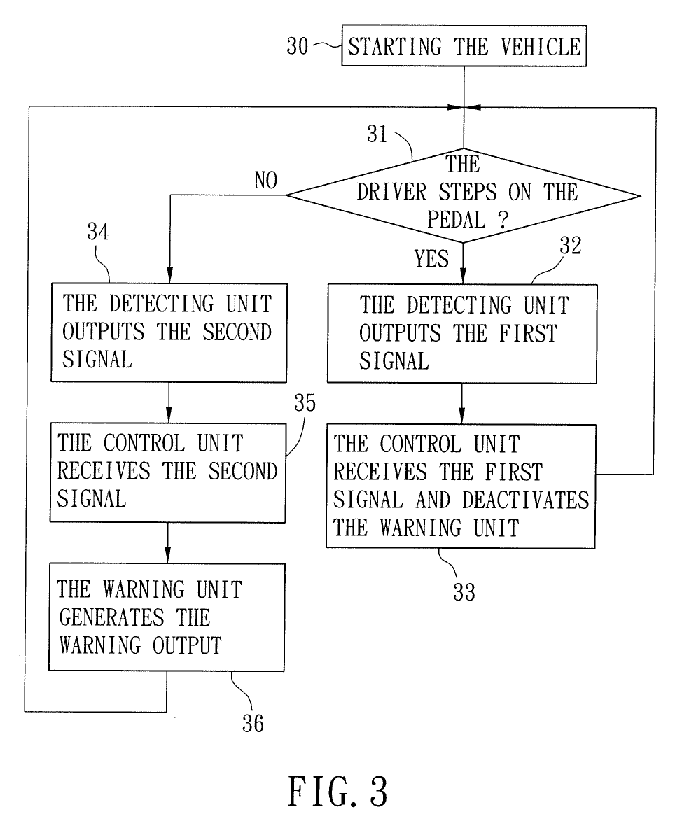

Operation of the vehicle deceleration warning device 2 of this embodiment will now be described with further reference to FIG. 3. After the vehicle is started in step 30, the flow proceeds to step 31 to determine whether the vehicle driver steps on the pedal 11 of the accelerator mechanism 1 of the vehicle via the detector component 210 of the detecting unit 21.

When the driver steps on the pedal 11, the signal-generating circuit 211 of the detecting unit 21 outputs the first signal in step 32. In step 33, the control circuit 233 of the control unit 23 receives the first signal generated by the signal-generating circuit 211, and deactivates the warning unit 22. Subsequently, the flow goes back to step 31.

When the driver releases the pedal 11 as a situation shown by dashed lines in FIG. 1, the signal-generating circuit 211 of the detecting unit 21 outputs the second signal in step 34. The control circuit 233 receives the second signal generated by the signal-generating circuit 211 in step 35, and controls the warning unit 22 to generate the warning output in step 36. Subsequently, the flow goes back to step 31. The warning unit 22 generates the warning output until the detector component 210 detects that the driver steps on the pedal 11 in step 31.

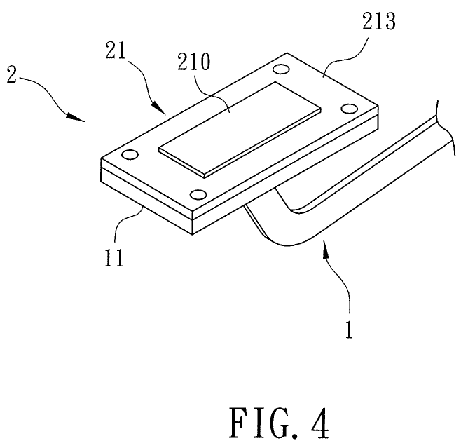

Referring to FIG. 4, a second preferred embodiment of the vehicle deceleration warning device 2 of this invention is shown to be similar to the first preferred embodiment. In this embodiment, the detecting unit 21 further includes a base 213 adapted to be mounted removably on the pedal 11 of the accelerator mechanism 1, and the detector component 210 is a mechanical switch, such as a micro switch, disposed on the base 213 for detecting whether the vehicle driver steps on the pedal 11.

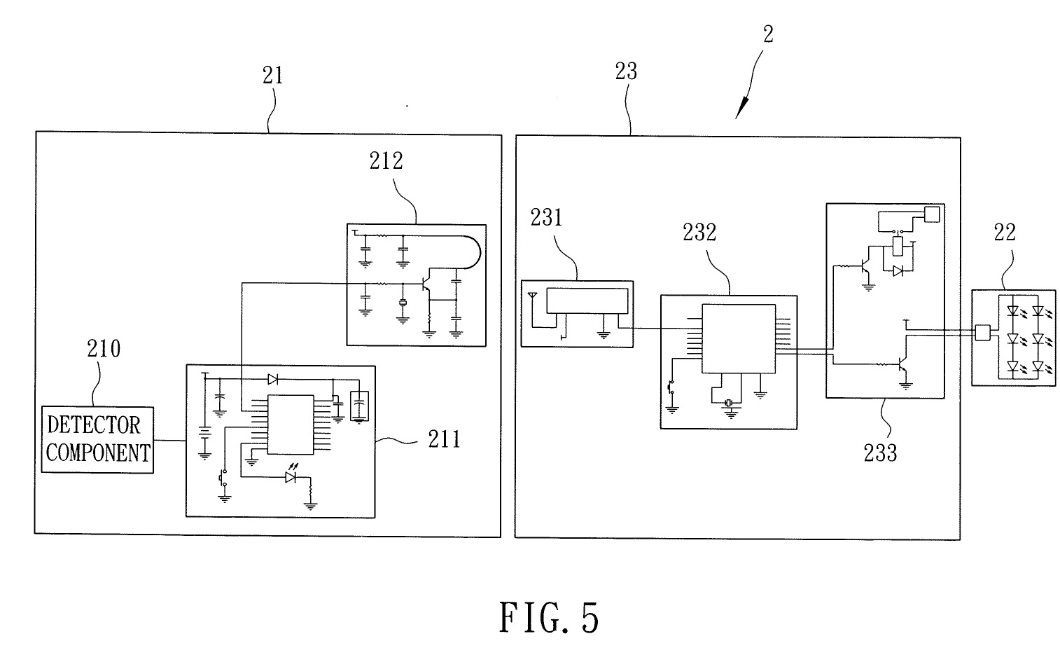

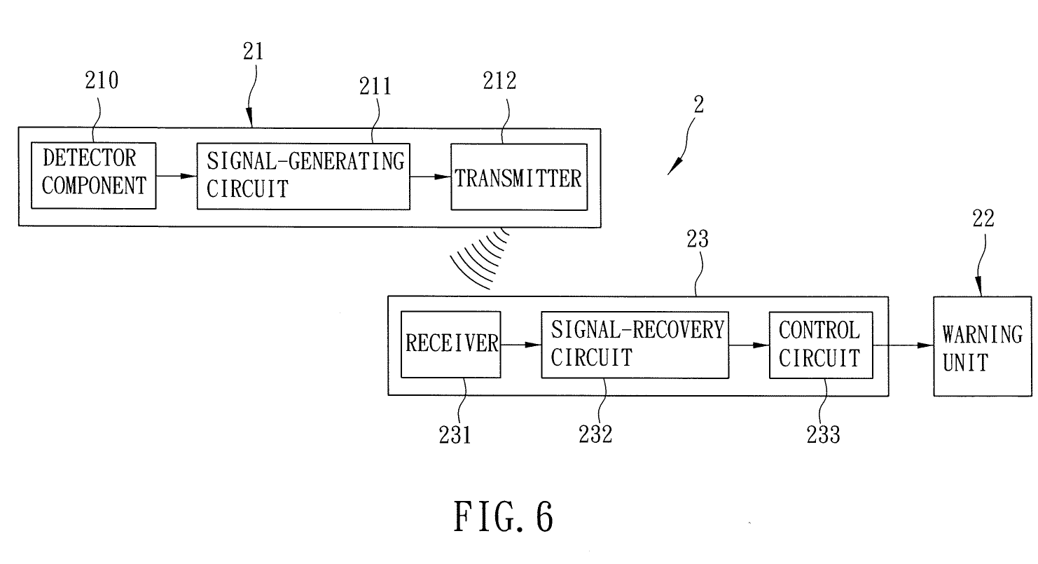

FIGS. 5 and 6 illustrate a third preferred embodiment of the vehicle deceleration warning device 2 of this invention, which is a modification of the first preferred embodiment. In this embodiment, the detecting unit 21 further includes a transmitter 212 electrically connected to the signal-generating circuit 211 for wireless transmission of the first or second signal generated by the signal-generating circuit 211. Moreover, the control unit 23 further includes a receiver 231 for wireless reception of the first or second signal transmitted by the transmitter 212, and a signal-recovery circuit 232 electrically connecting the receiver 231 and the control circuit 233 for providing the first or second signal received by the receiver 231 to the control circuit 233. By virtue of the transmitter 212, the receiver 231 and the signal-recovery circuit 232, it is relatively convenient to install the vehicle deceleration warning device 2 on the vehicle.

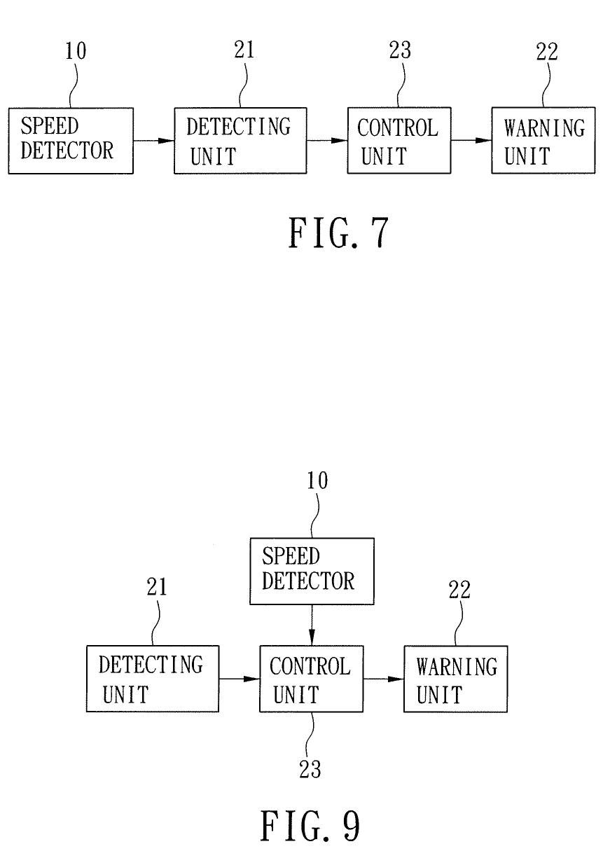

FIG. 7 illustrates a fourth preferred embodiment of the vehicle deceleration warning device 2 of this invention, which is another modification of the first preferred embodiment. In this embodiment, the vehicle further has a speed detector 10 for acquiring vehicle speed information. Preferably, the detecting unit 21 is adapted to be coupled to the speed detector 10, and is configured to detect the driver operation of the accelerator mechanism 1 only when the vehicle speed information from the speed detector 10 indicates that a current speed of the vehicle is faster than a predetermined threshold.

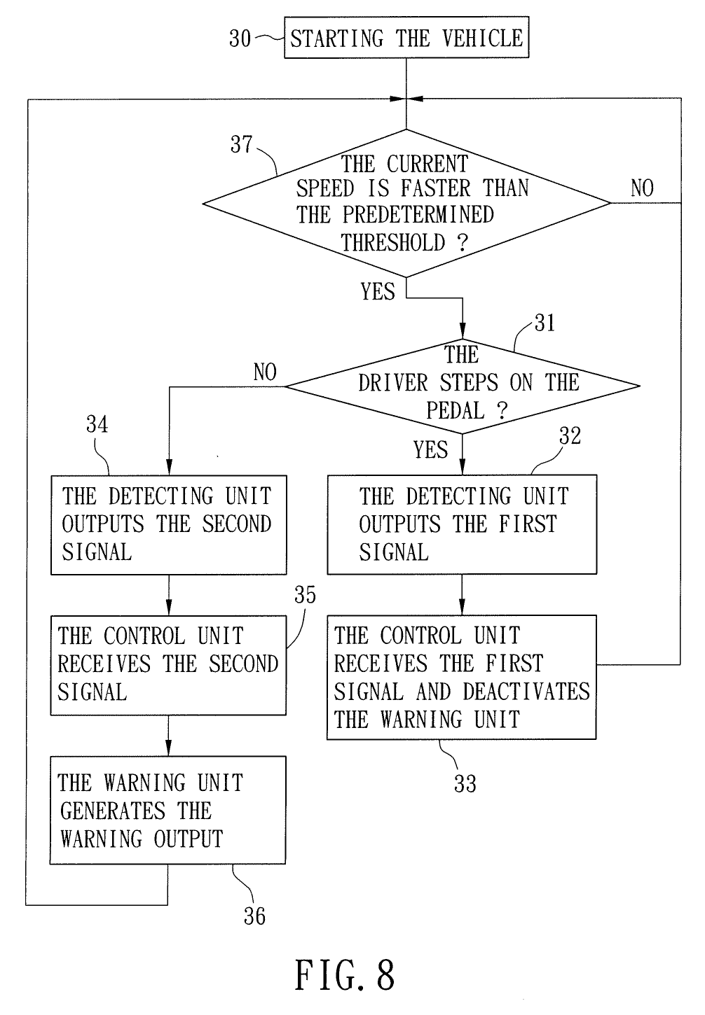

Referring to FIG. 8, after the vehicle is started, the vehicle deceleration warning device 2 begins acquiring the vehicle speed information from the speed detector 10 for determining whether the current speed of the vehicle is faster than the predetermined threshold via the detecting unit 21 in step 37. When the current speed of the vehicle is faster than the predetermined threshold, the vehicle deceleration warning device 2 operates by proceeding with the aforementioned steps as shown in FIG. 3, except that the flow goes back to step 37 rather than step 31 after step 33 or 36. When the current speed of the vehicle is slower that the predetermined threshold, the vehicle deceleration warning device 2 is inoperative. In practice, the speed detector 10 may be an engine control unit of the vehicle or an additional speed detecting component. Preferably, the predetermined threshold is adjustable to meet requirements of the driver.

Referring to FIG. 9, a fifth preferred embodiment of the vehicle deceleration warning device 2 of this invention is shown to be similar to the fourth preferred embodiment. In this embodiment, the control unit 23 is adapted to be coupled to the speed detector 10 of the vehicle, and is configured to control the warning unit 22 to generate the warning output when the control unit 23 receives the second signal from the detecting unit 21 and the vehicle speed information from the speed detector 10 indicates that the current speed of the vehicle is faster than the predetermined threshold.

In sum, the vehicle deceleration warning device 2 is capable of outputting the warning output before the driver brakes the vehicle so that rear vehicles may be warned at an earlier time. Moreover, by virtue of the speed detector 10, a situation where the vehicle deceleration warning device 2 always generates the warning output during city driving can be avoided, and electric power consumption of the vehicle deceleration warning device 2 can be reduced.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A vehicle deceleration warning device adapted for installation on a vehicle having an accelerator mechanism, said vehicle deceleration warning device comprising:
a detecting unit adapted for detecting driver operation of the accelerator mechanism, and configured to output a first signal when a vehicle driver manipulates the accelerator mechanism and to output a second signal when the vehicle driver releases the accelerator mechanism;
a warning unit adapted to be mounted on the vehicle and operable so as to generate a warning output; and
a control unit coupled to said detecting unit and said warning unit, said control unit responding to the first signal from said detecting unit by deactivating said warning unit and responding to the second signal from said detecting unit by controlling said warning unit to generate the warning output.

2. The vehicle deceleration warning device as claimed in claim 1, wherein said warning unit is a warning light set.

3. The vehicle deceleration warning device as claimed in claim 1, wherein:
said detecting unit includes a detector component adapted for detecting the driver operation of the accelerator mechanism, and a signal-generating circuit electrically connected to said detector component for generating one of the first and second signals based on an output of said detector component; and
said control unit includes a control circuit for receiving one of the first and second signals generated by said signal-generating circuit and for controlling operation of said warning unit accordingly.

4. The vehicle deceleration warning device as claimed in claim 3, wherein said detector component is a piezoelectric plate.

5. The vehicle deceleration warning device as claimed in claim 3, wherein said detector component is a mechanical switch.

6. The vehicle deceleration warning device as claimed in claim 3, wherein:
said detecting unit further includes a transmitter electrically connected to said signal-generating circuit for wireless transmission of said one of the first and second signals generated by said signal-generating circuit; and
said control unit further includes a receiver for wireless reception of said one of the first and second signals transmitted by said transmitter, and a signal-recovery circuit electrically connecting said receiver and said control circuit for providing said one of the first and second signals received by said receiver to said control circuit.

7. The vehicle deceleration warning device as claimed in claim 1, the vehicle further having a speed detector for acquiring vehicle speed information, wherein said detecting unit is adapted to be coupled to the speed detector and is configured to detect the driver operation of the accelerator mechanism only when the vehicle speed information from the speed detector indicates that a current speed of the vehicle is faster than a predetermined threshold.

8. The vehicle deceleration warning device as claimed in claim 1, the vehicle further having a speed detector for acquiring vehicle speed information, wherein said control unit is adapted to be coupled to the speed detector and is configured to control said warning unit to generate the warning output when said control unit receives the second signal from said detecting unit and the vehicle speed information from the speed detector indicates that a current speed of the vehicle is faster than a predetermined threshold.

9. The vehicle deceleration warning device as claimed in claim 1, wherein said detecting unit is a pressure-sensitive unit that is adapted for detecting a pressure exerted upon the accelerator mechanism by the vehicle driver, that outputs the first signal when the pressure is detected, and that outputs the second signal when the pressure is not detected.

10. The vehicle deceleration warning device as claimed in claim 1, wherein said detecting unit is adapted to be disposed on a pedal of the accelerator mechanism for detecting whether the vehicle driver steps on the pedal of the accelerator mechanism.

11. The vehicle deceleration warning device as claimed in claim 1, wherein said detecting unit is adapted to be operatively associated with a linkage of the accelerator mechanism for detecting movement of the linkage due to the vehicle driver stepping on the accelerator mechanism.

12. A warning light controller adapted for installation on a vehicle having an accelerator mechanism and a warning light set, said warning light controller comprising:
a detecting unit adapted for detecting driver operation of the accelerator mechanism, and configured to output a first signal when a vehicle driver manipulates the accelerator mechanism and to output a second signal when the vehicle driver releases the accelerator mechanism; and
a control unit coupled to said detecting unit and adapted to be coupled to the warning light set, said control unit responding to the first signal from said detecting unit by deactivating the warning light set and responding to the second signal from said detecting unit by controlling the warning light set to generate a warning output.

13. The warning light controller as claimed in claim 12, wherein:
said detecting unit includes a detector component adapted for detecting the driver operation of the accelerator mechanism, and a signal-generating circuit electrically connected to said detector component for generating one of the first and second signals based on an output of said detector component; and
said control unit includes a control circuit for receiving one of the first and second signals generated by said signal-generating circuit and for controlling operation of the warning light set accordingly.

14. The warning light controller as claimed in claim 13, wherein said detector component is one of a piezoelectric plate and a mechanical switch.

15. The warning light controller as claimed in claim 13, wherein:
said detecting unit further includes a transmitter electrically connected to said signal-generating circuit for wireless transmission of said one of the first and second signals generated by said signal-generating circuit; and
said control unit further includes a receiver for wireless reception of said one of the first and second signals transmitted by said transmitter, and a signal-recovery circuit electrically connecting said receiver and said control circuit for providing said one of the first and second signals received by said receiver to said control circuit.

16. The warning light controller as claimed in claim 12, the vehicle further having a speed detector for acquiring vehicle speed information, wherein said detecting unit is adapted to be coupled to the speed detector and is configured to detect the driver operation of the accelerator mechanism only when the vehicle speed information from the speed detector indicates that a current speed of the vehicle is faster than a predetermined threshold.

17. The warning light controller as claimed in claim 12, the vehicle further having a speed detector for acquiring vehicle speed information, wherein said control unit is adapted to be coupled to the speed detector and is configured to control the warning light set to generate the warning output when said control unit receives the second signal from said detecting unit and the vehicle speed information from the speed detector indicates that a current speed of the vehicle is faster than a predetermined threshold.

18. The warning light controller as claimed in claim 12, wherein said detecting unit is adapted to be disposed on a pedal of the accelerator mechanism for detecting whether the vehicle driver steps on the pedal of the accelerator mechanism.

19. The warning light controller as claimed in claim 12, wherein said detecting unit is adapted to be operatively associated with a linkage of the accelerator mechanism for detecting movement of the linkage due to the vehicle driver stepping on the accelerator mechanism.
